(19) United States
(12) Patent Application Publication
(10) Pub. No.: US 2026/0353118 A1
(43) Pub. Date: Nov. 5, 2026

(54) ADAPTIVE QUALITY OF SERVICE

(71) Applicant: Sony Group Corporation, Tokyo (JP)

(72) Inventors: Svante ALNAS, Lund (SE); Torgny PALENIUS, Barsebäck (SE); Basuki PRIYANTO, Lund (SE); Anders BERGGREN, Lund (SE)

(21) Appl. No.: 18/997,567

(22) PCT Filed: Aug. 2, 2023
(86) PCT No.: PCT/EP2023/071388

§ 371 Date: Jan. 22, 2025

(30) Foreign Application Priority Data
Aug. 5, 2022 (SE) 2250950-9

(51) Int. Cl. H04W 24/08; H04L 5/00; H04W 8/22; H04W 28/02

(52) U.S. Cl. CPC H04W 24/08; H04L 5/0053; H04W 8/22; H04W 28/0268

(57) ABSTRACT

Examples disclose a method of operating an access node (AN), comprising obtaining a data package set, obtaining information on the data package set, wherein the data package set comprises data packages including payload data packages and correction data packages, transmitting data packages of the data package set on a wireless channel, and monitoring, on the wireless channel, for acknowledge signals associated with the transmitted data packages, wherein the information on the data package set enables the AN to refrain from transmitting at least one remaining data package in response to received acknowledge signals. Additional examples disclose a method of operating a core network comprising providing to an application function node (AF) a message indicative of the core network supporting a data package set based QoS. Further examples disclose an access node and a core network node.

### TECHNICAL FIELD

The current disclosure relates to transmission of data packages in a communication network.

### BACKGROUND

Many Extended Reality (XR) applications such as Virtual Reality (VR), Augmented Reality (AR) and/or Cloud Gaming (CG) applications require a high data rate and low latency. Data associated with XR applications may be provided in form of data package sets. Each data package set comprises data packages including payload data packages. The individual data packages are transmitted from an access node (AN) to a mobile device or user equipment (UE) over a wireless channel and the UE uses the data packages of the data packages set to decode the XR data. Sometimes, one or more data packages may not be received by the UE, for example, due to a bad wireless channel condition. The data packages of each data package set may include correction data packages. Said correction data packages may allow for decoding the data package set in the event that some data packages of the data package set are not received. Transmitting correction data packages in addition to payload data packages may result in a reduced data rate. It may also be possible to re-transmit data packages of the data package set in the event that a data package has not been received by the UE. However, this may induce additional latency and/or reduced data rate.

### SUMMARY

Hence, there may be a need for methods of communicating in a communication network allowing for a more efficient usage of wireless resources to obtain a high data rate and low latency.

Said need has been addressed with the subject-matter of the independent claims. Advantageous embodiments are described in the dependent claims.

Examples disclose method of operating an access node (AN) comprising: obtaining, in particular from an application server node (AS) a data package set, obtaining information on the data package set, wherein the data package set comprises data packages including payload data packages and correction data packages; transmitting data packages of the data package set, by the AN on a wireless channel, and monitoring, on the wireless channel, for acknowledge signals associated with the transmitted data packages, wherein the information on the data package set enables the AN to refrain from transmitting at least one remaining data package in response to received acknowledge signals from the UE.

Further examples disclose a method of operating a core network comprising providing, in particular by a network exposure function node (NEF), to an application function node, AF, a message indicative of the core network supporting a data package set based QoS.

Additional examples disclose an access node comprising control circuitry configured for performing the respective aforementioned method and a core network node comprising control circuitry configured for performing the respective aforementioned method.

### BRIEF DESCRIPTION OF THE DRAWINGS

FIG. 1 schematically illustrates a data package set;

FIG. 2 schematically illustrates a transmission of a data package set;

FIG. 3 schematically illustrates a transmission of a data package set;

FIG. 4 schematically illustrates a communication network;

FIG. 5 schematically illustrates a communication network node;

FIG. 6 schematically illustrates a method of operating an access node; and

FIG. 7 schematically illustrates a method of operating a core network.

### DETAILED DESCRIPTION

The radio access technology (RAT) 5G NR (New Radio) was introduced by the 3rd Generation Partnership Project (3GPP) to support enhanced mobile broadband (eMBB) for high data rates, ultra reliable and low latency communication (uRLLC) (low latency), and massive machine type communication (mMTC).

Extended Reality (XR) applications become more and more widespread. XR applications cover several applications, such as Virtual Reality (VR), Augmented Reality (AR), and Cloud Gaming (CG) applications. XR applications may require both a relatively high data rates and low latency. As 5G NR was not designed to support the combination of the aforementioned requirements, XR applications may not be supported optimally in 5G NR networks and user experience may suffer because the required data rate/latency may not be reached and UE power consumption may be high.

XR applications may have the unique characteristic that the associated traffic pattern is deterministic (i.e., have a certain periodicity and certain number of traffic flows). There may be further relevant other applications with multiple data streams having different characteristics, like factory automation, remote machine operation, and unmanned aerial vehicle (UAV) operation, or applications requiring a differentiation between video and audio.

For XR applications or media services, a data package set, which may correspond to a PDU (payload data unit) set as described in TR 23.700-60 version 0.3.0, may be used to carry the payload (e.g. a frame, video slice/tile). In media layer, data packages of such a data package set may be decoded/handled as a whole.

For example, the frame/video slice may only be decoded in case all of the data packages carrying the frame/video slice are successfully delivered. In video coding, groups of pictures (GOPs) are commonly used. A GOP is a collection of successive pictures within a coded video stream. A GOP may contain the following picture types:
an I picture (intra coded picture, also called keyframe or i-frame), i.e. a picture that is coded independently of all other pictures;
a P picture (predictive coded picture, also called P frame), which contains motion-compensated difference information relative to one or more previously decoded pictures. According to some codecs, e.g. H.262/MPEG-2, each P picture can only reference one picture, that picture must precede the P picture in display order as well as in decoding order, and that picture must be an I or P picture. Further codecs, e.g. HEVC, are free from said constraints on the P picture.
a B picture (bi-predictive coded picture, also called B frame), which contains motion-compensated difference information relative to previously decoded pictures. In some older designs, e.g. MPEG-1 and H.262/MPEG-2, each B picture can only reference two pictures, the one which precedes the B picture in display order and the one which follows, and all referenced pictures must be I or P pictures. These constraints do not necessary apply to newer standards, e.g. H.264/MPEG-4 AVC and HEVC.
a D picture (direct coded, DC, picture), which serves as a fast-access representation of a picture for loss robustness or fast-forward. D pictures are only used in some codecs, e.g. MPEG-1.

Each GOP begins (in decoding order) with an I picture which also indicates the beginning of the GOP. Afterwards several P and B frames follow. A frame within a GOP can only be decoded by the client in case all frames on which that frame depends are successfully received.

The GOP may serve as an example that data packages of a data package set may have an inherent dependency on each other, e.g. in a media layer. Taking such dependencies into account may increase scheduling efficiency.

Some media formats may include systematic forward error corrections (FEC), meaning that redundancy bits are added after the actual media data (payload). The redundancy bits are only needed if some pieces of the payload data is missing. Then, the FEC data may be used for decoding. This only works if a small part of the payload data is missing. This technique is commonly used in broadcast/multicast services.

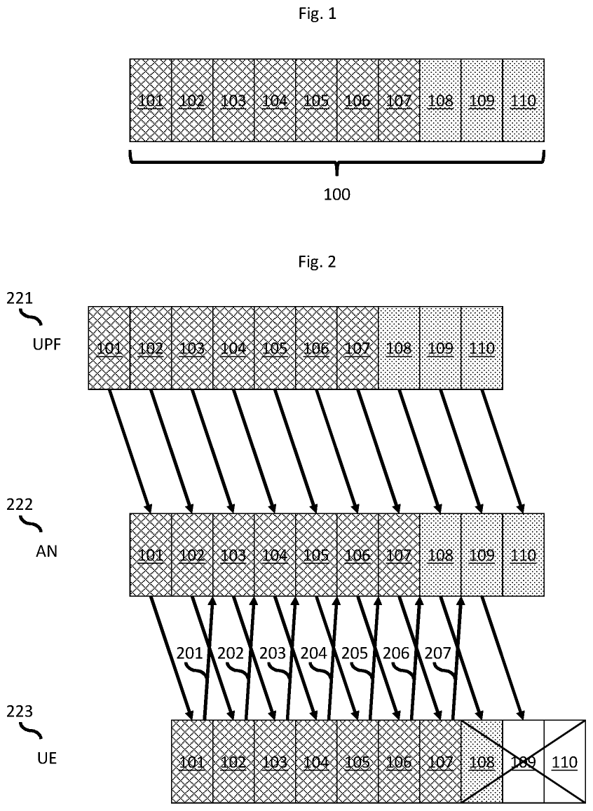

FIG. 1 illustrates a data package set 100 comprising data packages 101, . . . , 110. The data packages 101, . . . , 110 include payload data packages 101, . . . , 107 and correction data packages 108, . . . , 110. The correction data packages 108, . . . , 110 may comprise forward error correction data packages.

FIG. 2 illustrates a transmission of payload data from a core network node 221, e.g. a user plane function node (UPF), via an AN 222, e.g. a radio access node (RAN) or gNodeB (gNB), over a wireless channel to a UE 223 using the data package set 100.

The AN 222 obtains the data package set 100 and obtains information on the data package set 100. The data package set 100 comprises data packages 101, . . . , 110 including payload data packages 101, . . . , 107 and correction data packages 108, . . . , 110.

The AN 222 transmits data packages 101, . . . of the data package 100 on a wireless channel and monitors, on the wireless channel, for acknowledge signals 201, . . . associated with the transmitted data packages 101, . . . . The information on the data package set enables the AN 222 to refrain from transmitting at least one remaining data package in response to received acknowledge signals 201, . . . . For example, the AN 222 may refrain from transmitting the data packages 109, 110 in response to the received acknowledge signals 201, . . . , 207 and the information on the data package set 100.

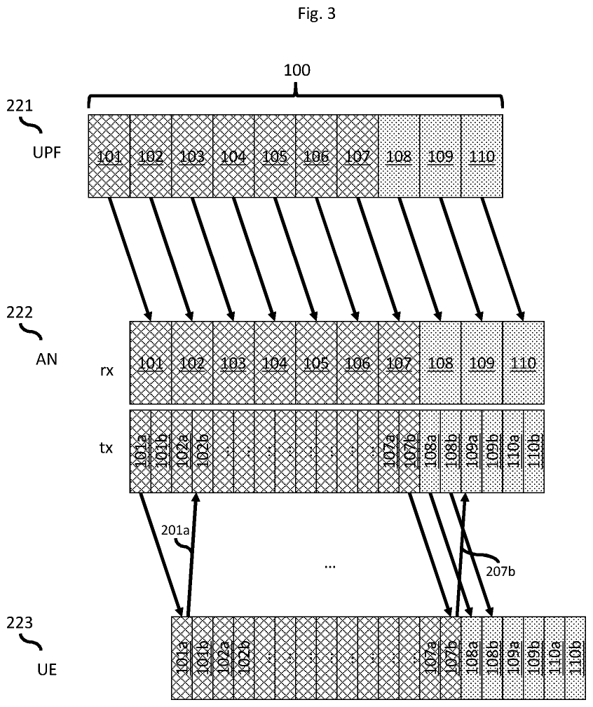

As shown in FIG. 3, the AN 222 may receive the data package set 100 from the UPF 221 in the form of data packages 101, . . . 110. The AN 222 may divide the data package set 100 in different data packages 101a, 101b, 102a, 102b, . . . , 110a, 110b. The AN 222 may receive the data packages 101, . . . , 110 from the UPF 221, unpack them and then pack them again in new data packages 101a, 101b, . . . , 110a, 110b. The AN 222 may add headers to the data packages 101a, 101b, . . . , 110a, 110b. The header may relate to a RAN protocol. The new headers may relate to a packet data convergence protocol (PDCP), to radio link control (RLC) protocol, medium access control (MAC) protocol, and/or the physical layer. In particular, the AN 222 may divide the data package set 100 in multiple smaller data packages 101a, . . . , 110b which are to be transmitted to the UE 223. For example, the AN 222 may divide the data package 101 into two data packages 101a, 101b. Accordingly, the AN 222 receives a separate acknowledge signal 201a after having transmitted the data package 101a.

In the example shown in FIG. 2, the payload data packages 101, . . . , 107 are transmitted before the correction data packages 108, . . . , 110. However, a different order of the payload data packages and the correction data packages may also be possible. For example, correction data packages may be transmitted between payload data packages.

The information on the data package set 100 may comprise information on the amount of payload data packages and the amount of correction data packages comprised in the data package set 100. For example, the information on the data package set 100 may indicate that the data package set 100 comprises seven payload data packages 101, . . . , 107 and three correction data packages 108, . . . , 110. The information on the data package set 100 may indicate that the first in sequence data packages are payload data packages and the remaining data packages are correction data package. The information on the data package set 100 may indicate which data package of the data package set is a payload data package and which data package of the data package set is a correction data package. The information on the data package set 100 may include at least one of an identifier of the data package set, a size of a payload data package and/or correction data package of the data package set, a number of payload data packages and/or a number of correction data packages of the data package set.

In some examples, obtaining information on the data package may comprise decoding at least one data package of the data package set. Obtaining information on the data package set may also comprise obtaining information on the data package set from a user plane function node (UPF). Further examples may prescribe decoding a header of the data package set.

The acknowledge signals 201, . . . , 207 may indicate that the UE 223 has received all payload data packages 101, . . . , 107 or corresponding data packages. Thus, the transmission of the not yet transmitted correction data packages 109, 110 may be omitted. This may considerably reduce consumption of limited wireless resources. In some examples, based on the information on the data package set, the AN may derive how many correction data packages will have to be transmitted if a certain number of acknowledge signals associated with payload data packages have not been received. For example, if the AN 222 only fails to receive one acknowledge signal associated with a payload data package, not all correction data packages may be required and the transmission of at least some of the not required correction data packages may be omitted. In further scenarios, it may be determined that too few acknowledge signals associated with payload data packages and/or correction data packages have been received and the AN 222 may refrain from transmitting any further data packages of the data package set, because the data package set cannot be decoded anyway. This may make wireless resources available for other purposes again. For example, the freed wireless resources could be used to accelerate the transmission of following data package sets.

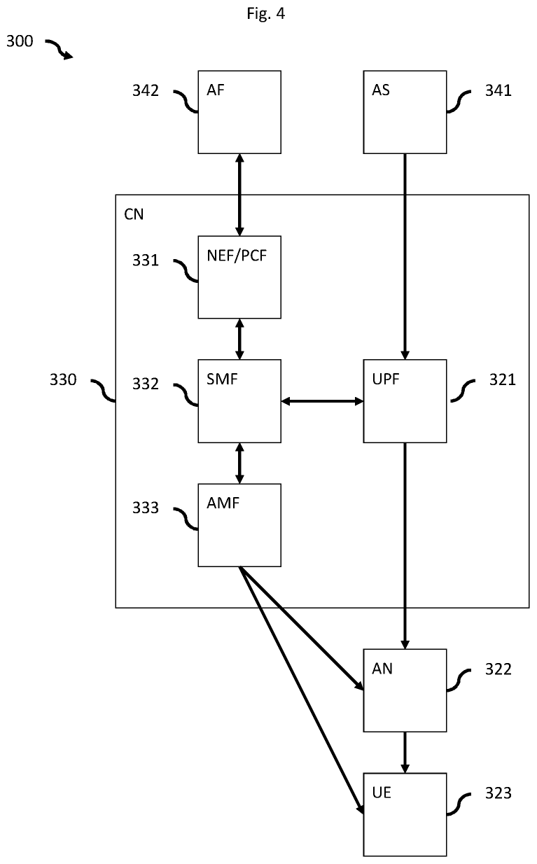

FIG. 4 illustrates a communication network 300 comprising a UE 323, an AN 322, in particular a radio access node (RAN), a core network 330, an application function node (AF) 342 and an application server node (AS) 341. The core network 330 may be a 5G core network as specified by the 3GPP. The core network 330 may comprise several core network nodes, in particular a policy control function and/or network exposure function node (PCF/NEF) 331, a session management function node (SMF) 332, an access and mobility management function node (AMF) 333, and/or a user plane function node (UPF) 321.

In legacy 5G systems (5GS), the Quality-of-Service (QoS) Flow is the finest granularity of QoS differentiation during a session, in which data packages, in particular PDUs, are transmitted. A 5G QoS Identifier (5QI) may be used as a pointer to a set of QoS characteristics (e.g., priority level, packet delay, packet error rate, etc.) required for a flow of data packages. Typically, each data package in a QoS flow of data packages is treated according to the same required QoS characteristics. In some scenarios, data packages in a QoS flow of data packages may be grouped in data package groups. A QoS characteristic may be defined for each data package group. The data package group may not be useful until all data packages are transmitted. All data packages of a data package group may be required to have the same QoS characteristic since either the data package group is delivered in time or not needed at all.

The method explained herein before, wherein the AN is provided with information on a data package set to be transmitted comprising payload data packages and correction data packages, may allow for a more efficient usage of wireless resources. Not all incompletely transmitted data package sets may have to be discarded. Some partially transmitted data package sets may still be used, when enough correction data packages are successfully received. Nevertheless a transmission of redundant data packages may be omitted if sufficient payload data packages are successfully communicated between the AN and the UE, I.e. successfully transferred.

Signaling between the nodes of the communication network 300 may be required to enable the efficient usage of wireless resources for transmission of data involving using data package sets comprising payload data packages and correction data packages.

A method of operating the core network 330 may comprise providing to the application function node 342 a message indicative of the core network 330 supporting a data package set based QoS. Thus, the application function node 342 may be made aware that the core network 330 actually supports the advantageous transmission of data package sets described hereinbefore. The message may be provided by a network exposure function node (NEF) 331 of the core network 330.

The core network 330 may obtain from the AF 342 a message indicative of a traffic flow comprising data package sets, wherein each data package set includes at least one data package, to be transmitted on a wireless channel from the AN 322 to the UE 323 using a data package set based QoS. Thus, the core network 330 may be made aware that a data flow received from the AS 341 may have to be treated according to the data package set based QoS. The message may be obtained by the NEF 331 of the core network 330.

Further, the core network 330 may exchange with the AF 342 a message enabling the core network 330 to identify if a data package of a data package set is a payload data package or a correction data package. The core network 330 may provide the AF 342 with the message enabling the core network 330 to identify if a data package of a data package set is a payload data package or a correction data package. For example, the message may be used to instruct the AF 342 to mark the data packages accordingly. Marking may include adding a header to the data packages. In particular, it may set a flag of the data package accordingly. The core network 330 may also obtain from the AF 342 the message enabling the core network 330 to identify if a data package of a data package set is a payload data package or a correction data package. For example, the AF 342 may inform the core network 330 that the data packages have been marked accordingly. In particular, the message may be exchanged between the AF 342 and the NEF 331 of the core network 330.

In addition, the core network 330 may exchange with the AF 342 a message indicative of a data package set based QoS characteristic for the data package sets. The characteristics may include at least one of a priority level, packet delay, packet error rate, etc. required for the transmission of the data package sets. The message may directly specify the priority level and/or packet delay and/or packet error rate. The message may also comprise a pointer to a predefined set of QoS characteristics. The message may be exchanged between the AF 342 and the NEF 331.

A core network node, in particular the UPF 321, may obtain a message enabling the core network node to detect a data package set. For example, the SMF 332 may provide the message to the UPF 321.

A method of operating the core network 330 may prescribe adding, by a core network node, in particular by the UPF 321, a header, in particular a GTP-U header, to a data package of a transmitted data package set, wherein the header is indicative of the data package being a payload data package or a correction data package. The header may enable the AN 322 to identify whether the AN 322 may refrain from transmitting the data package as explained further below. The header may indicate if a data package is a first data package of a data package set. In particular, the header may allow for separating data package sets arriving in sequence. The header may indicate that the respective data package set forms the border between data package sets. The header may indicate the data package set the data package belongs to.

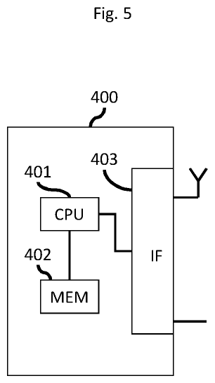

FIG. 5 schematically illustrates a node 400 of a communication network, e.g. the communication network 300. The node 400 may correspond to any one of the nodes 342, 341, 331, 332, 333, 321, 322, 323. The node 400 comprises control circuitry including a processor 401, a memory 402 and an interface 403 for communication with other nodes via a wired or wireless connection. The control circuitry of the node 400 may be configured to perform a method as described hereinbefore.

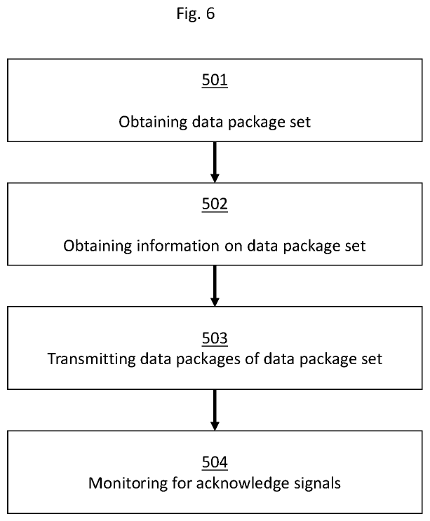

As shown in FIG. 6, a method of operating an access node, AN, comprises obtaining (501) a data package set, obtaining (502) information on the data package set. The data package set comprises data packages including payload data packages and correction data packages. A message providing information on the data package set makes it possible for the AN to decide that the transmission of a certain data package may be omitted without compromising the decodability of the data package set. The method further comprises transmitting (503) data packages of the data package set, by the AN on a wireless channel. The method also includes monitoring for acknowledge signals associated with the transmitted data packages. In some examples, a separate acknowledge signal may be expected for each transmitted data package. In other examples, an acknowledge signal may be expected for a group of data packages. The information on the data package set enables the AN to refrain from transmitting at least one remaining data package in response to received acknowledge signals. In particular, the information on the data package may indicate that the AN may refrain from transmitting at least one remaining data package in response to received acknowledge signals without compromising the decodability of the data package set by the receiver of the transmitted data packages. The receiver of the transmitted data packages may be able to decode the higher layer data even if the transmission of some of the data packages is omitted. The AN may obtain some general configuration related to a stream of data package sets from a core network node, for example an AMF. Further details of each data package set and/or data packages included in the data package set may be received via a GTP-U header of a data package set added by a further core network node, for example the UPF. The information on the data package set may be obtained before or after the data package set itself.

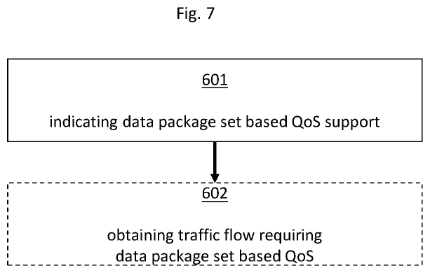

FIG. 7 illustrates a method of operating a core network comprising providing (601) to an AF a message indicative of the core network supporting a data package set based QoS. The method may further comprise obtaining (602) a message indicative of a traffic flow comprising data package sets, wherein each data package set includes at least one data package to be transmitted on a wireless channel from an AN to a UE using a data package set based QoS.

Summarizing, at least the following EXAMPLEs have been described above:

EXAMPLE 1. A method of operating an access node, AN (322), comprising
obtaining (501 a data package set,
obtaining (502) information on the data package set (100),
wherein the data package set (100) comprises data packages (101, . . . , 110) including payload data packages (101, . . . , 107) and correction data packages (108, . . . , 110),
   transmitting (503) data packages (101, . . . , 108) of the data package set (100) on a wireless channel, and
   monitoring (504), on the wireless channel, for acknowledge signals (201, . . . , 207) associated with the transmitted data packages (101, . . . , 108),
wherein the information on the data package set (100) enables the AN (322) to refrain from transmitting at least one remaining data package (109, 110) in response to received acknowledge signals (201, . . . , 207).

EXAMPLE 2. The method of operating the AN (322) of EXAMPLE 1,
wherein obtaining (502) information on the data package set (100) comprises decoding at least one data package of the data package set (100).

EXAMPLE 3. The method of operating the AN (322) of EXAMPLE 1 or 2,
wherein obtaining (502) information on the data package set (100) comprises obtaining information on the data package set (100) from a user plane function node, UPF (321).

EXAMPLE 4. The method of operating the AN (322) of any one of EXAMPLEs 1 to 3,
wherein obtaining (502) information on the data package (100) set comprises decoding a header of the data package set (100).

EXAMPLE 5. The method of operating the AN (322) of any one of EXAMPLEs 1 to 4,
wherein the data package set (100) comprises a payload data unit and/or wherein the data package set comprises a payload data unit set.

EXAMPLE 6. The method of operating the AN (322) of any one of EXAMPLEs 1 to 5,
wherein the correction data packages (108, . . . , 110) comprise redundant data packages.

EXAMPLE 7. The method of operating the AN of any one of EXAMPLEs 1 to 6,
wherein the correction data packages (108, . . . , 110) comprise forward error correction data packages

EXAMPLE 8. The method of operating the AN (322) of any one of EXAMPLEs 1 to 7,
wherein information on the data package set (100) includes a quality of service, QoS, indicator associated with the data package set (100).

EXAMPLE 9. The method of operating an AN (322) of any one of EXAMPLEs 1 to 8, further comprising
obtaining a message indicative of a data package set based QoS characteristic for the data package set;
allocating wireless resources based on the message indicative of the data package set based QoS characteristic for the data package set.

EXAMPLE 10.A method of operating a core network comprising
providing (601 to an application function node, AF, a message indicative of the core network supporting a data package set based QoS.

Example 11. The method of operating the core network of EXAMPLE 10, further comprising
obtaining (602) from the AF a message indicative of a traffic flow comprising data package sets, wherein each data package set includes at least one data package, to be transmitted on a wireless channel from an AN to a UE using a data package set based QoS.

EXAMPLE 12. The method of operating the core network of EXAMPLE 10 or 11 further comprising:
exchanging with the AF a message enabling the core network to identify if a data package of a data package set is a payload data package or a correction data package.

EXAMPLE 13. The method of core network node of any one of EXAMPLEs 10 to 12, further comprising:
exchanging with the AF a message indicative of a data package set based QoS characteristic for the data package sets.

EXAMPLE 14. The method of operating the core network of any one of EXAMPLEs 10 to 13, further comprising
providing to a core network node a message enabling the core network node to detect a data package set.

EXAMPLE 15. The method of operating the core network of any one of EXAMPLEs 10 to 14, further comprising
adding, by a core network node, a header to a data package of a transmitted data package set, wherein the header is indicative of the data package being a payload data package or a correction data package.

1. A method of operating an access node (AN), comprising
obtaining, in particular from an application server node, AS, a data package set,
obtaining information on the data package set,
wherein the data package set comprises data packages including payload data packages and correction data packages,
transmitting data packages of the data package set (100) on a wireless channel, and
monitoring, on the wireless channel, for acknowledge signals associated with the transmitted data packages,
wherein the information on the data package set enables the AN to refrain from transmitting at least one remaining data package in response to received acknowledge signals.

2. A method of operating an access node (AN), comprising
obtaining, in particular from an application server node, AS, a data package set,
obtaining information on the data package set,
wherein the data package set comprises data packages including payload data packages and correction data packages,
transmitting data packages of the data package set, by the AN on a wireless channel,
monitoring, on the wireless channel, for acknowledge signals associated with the transmitted data packages,
refraining to transmit at least one remaining data package in response to received acknowledge signals and the information on the data package set.

3. The method of operating the AN of claim 1, wherein obtaining information on the data package set comprises decoding at least one data package of the data package set.

4. The method of operating the AN of claim 1, wherein obtaining information on the data package set comprises obtaining information on the data package set from a user plane function node, UPF.

5. The method of operating the AN of claim 1, wherein obtaining information on the data package set comprises decoding a header of the data package set.

6. The method of operating the AN of claim 1, wherein the data package set comprises a payload data unit and/or wherein the data package set comprises a payload data unit set.

7. The method of operating the AN of claim 1, wherein the correction data packages comprise redundant data packages.

8. The method of operating the AN of claim 1, wherein the correction data packages comprise forward error correction data packages

9. The method of operating the AN of claim 1, wherein information on the data package set includes a quality of service, QoS, indicator associated with the data package set.

10. The method of operating the AN of claim 1, further comprising
obtaining, in particular from a core network node, more particularly from an SMF, a message indicative of a data package set based QoS characteristic for the data package set;
allocating wireless resources based on the message indicative of the data package set based QoS characteristic for the data package set.

11. A method of operating a core network comprising
providing, in particular by a network exposure function node (NEF), to an application function node (AF), a message indicative of the core network supporting a data package set based QoS.

12. The method of operating the core network of claim 11, further comprising
obtaining from the AF, in particular by a or the NEF of the core network, a message indicative of a traffic flow comprising data package sets, wherein each data package set includes at least one data package, to be transmitted on a wireless channel from an AN to a UE using a data package set based QoS.

13. The method of operating the core network of claim 11, in particular a core network node of the core network, more particularly, the network exposure function node (NEF), further comprising:
exchanging with the AF, in particular between the AF and the NEF, more particularly obtaining from the AF or providing to the AF, a message enabling the core network to identify if a data package of a data package set is a payload data package or a correction data package.

14. The method of core network node of claim 11, further comprising:
exchanging with the AF, in particular between the AF and a or the NEF, more particularly obtaining from the AF or providing to the AF, a message indicative of a data package set based QoS characteristic for the data package sets.

15. The method of operating the core network of claim 11, further comprising
providing to a core network node, in particular to a UPF, more particularly from a session management function node (SMF), a message enabling the core network node to detect a data package set.

16. The method of operating the core network of claim 11, further comprising
adding, by a core network node, in particular by a UPF, a header, in particular a GTP-U header, to a data package of a transmitted data package set, wherein the header is indicative of the data package being a payload data package or a correction data package.

17. An access node comprising control circuitry, wherein the control circuitry is configured to perform the method according to claim 1.

18. A core network node comprising control circuitry wherein the control circuitry is configured to perform the method according to claim 11.
